(19) United States
(12) Patent Application Publication
(10) Pub. No.: US 2026/0140536 A1
(43) Pub. Date: May 21, 2026

(54) OUTER CASE FOR FOLDABLE ELECTRONIC DEVICE

(71) Applicant: Samsung Electronics Co., Ltd., Suwon-si (KR)

(72) Inventors: Jieun MYUNG, Suwon-si (KR); Kihwan KWON, Suwon-si (KR); Namsu KIM, Suwon-si (KR); Dahyun LEE, Suwon-si (KR); Miri LEE, Suwon-si (KR); Sungwook LEE, Suwon-si (KR); Jiyun LIM, Suwon-si (KR); Duyeong CHOI, Suwon-si (KR)

(21) Appl. No.: 19/450,116

(22) Filed: Jan. 15, 2026

Related U.S. Application Data
(63) Continuation of application No. PCT/KR2024/010937, filed on Jul. 26, 2024.

(30) Foreign Application Priority Data
Jul. 26, 2023 (KR) 10-2023-0097526
Sep. 25, 2023 (KR) 10-2023-0128310

(51) Int. Cl. G06F 1/16

(52) U.S. Cl. CPC G06F 1/1628; G06F 1/1616; G06F 1/1647; G06F 1/1681; G06F 2200/1632

(57) ABSTRACT

An outer case for a foldable electronic device is provided. The outer case includes a first case configured to be attached to a first housing of the foldable electronic device, a second case configured to be attached to a second housing of the foldable electronic device hinge-connected to the first housing, a pen holder configured to be positioned in a hinge housing between the first housing and the second housing when the foldable electronic device is in a folded state and to accommodate a pen, a first magnet disposed in the pen holder, a second magnet disposed in the pen holder, a third magnet disposed in the second case, a fourth magnet disposed in the first case, and a fifth magnet disposed in the first case, wherein one end of the pen holder is attached to the second case through an attractive force between the second magnet and the third magnet, wherein when the foldable electronic device is in an unfolded state, the other end of the pen holder is attached to the first case via the attraction between the first magnet and the fourth magnet, and wherein when the foldable electronic device is in the folded state, the other end of the pen holder is attached to the first case via the attraction between the first magnet and the fifth magnet.

### CROSS-REFERENCE TO RELATED APPLICATION(S)

This application is a continuation application, claiming priority under 35 U.S.C. § 365(c), of an International application No. PCT/KR 2024/010937, filed on Jul. 26, 2024, which is based on and claims the benefit of a Korean patent application number 10-2023-0097526, filed on Jul. 26, 2023, in the Korean Intellectual Property Office, and of a Korean patent application number 10-2023-0128310, filed on Sep. 25, 2023, in the Korean Intellectual Property Office, the disclosure of each of which is incorporated by reference herein in its entirety.

### BACKGROUND

### 1. Field

The disclosure relates to an outer case for a foldable electronic device.

### 2. Description of Related Art

A pen input device (also referred to as an electronic pen or a stylus pen) may increase usability of a foldable electronic device having a user experience with a large screen. While securing a space for mounting the pen input device inside the foldable electronic device, there is difficulty in maintaining thickness and weight of the foldable electronic device at an appropriate level, and, since it is also difficult to reduce a battery size in order to secure a battery capacity in an aspect of battery consumption due to the large screen, the foldable electronic device may be provided so that the pen input device is not built in. A method of storing the pen input device in an outer case configured to be attachable to and detachable from the foldable electronic device, not a method of storing the pen input device inside the foldable electronic device, may be provided.

The above information is presented as background information only to assist with an understanding of the disclosure. No determination has been made, and no assertion is made, as to whether any of the above might be applicable as prior art with regard to the disclosure.

### SUMMARY

When an outer case for a foldable electronic device is implemented to store a pen input device, such needs to be devised so that usability and aesthetics are not degraded.

Aspects of the disclosure are to address at least the above-mentioned problems and/or disadvantages and to provide at least the advantages described below. Accordingly, an aspect of the disclosure is to provide an outer case for a foldable electronic device that improves usability and aesthetics.

Additional aspects will be set forth in part in the description which follows, and, in part, will be apparent from the description, or may be learned by practice of the presented embodiments.

In accordance with an aspect of the disclosure, an outer case for a foldable electronic device is provided. The outer case includes a first case configured to be attached to a first housing of the foldable electronic device, a second case configured to be attached to a second housing of the foldable electronic device hinge-connected to the first housing, a pen holder configured to be positioned at a hinge housing between the first housing and the second housing when the foldable electronic device is in a folding state and to accommodate a pen, a first magnet disposed in the pen holder, a second magnet disposed in the pen holder, a third magnet disposed in the second case, a fourth magnet disposed in the first case, and a fifth magnet disposed in the first case, wherein one end of the pen holder is attached to the second case through an attractive force between the second magnet and the third magnet, wherein in an unfolding state of the foldable electronic device, through an attractive force between the first magnet and the fourth magnet, the other end of the pen holder is attached to the first case, and wherein in a folding state of the foldable electronic device, through an attractive force between the first magnet and the fifth magnet, the other end of the pen holder is attached to the first case.

In accordance with another aspect of the disclosure, an outer case for a foldable electronic device is provided. The outer case includes a first case configured to be attached to a first housing of the foldable electronic device, a second case configured to be attached to a second housing of the foldable electronic device hinge-connected to the first housing, a pen holder configured to cover a hinge housing between the first housing and the second housing when the foldable electronic device is in a folding state, and to accommodate a pen, at least one first magnet disposed in the pen holder and providing a magnetic force to attach the pen holder to the first case, and at least one second magnet disposed in the pen holder and providing a magnetic force to attach the pen holder to the second case, wherein an attractive force between the at least one second magnet and the second case is configured to be stronger than an attractive force between the at least one first magnet and the first case.

The outer case for a foldable electronic device according to various embodiments of the disclosure enhances usability and aesthetics.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view illustrating appearances of an unfolded state of a foldable electronic device to which an outer case is attachable and detachable, according to an embodiment of the disclosure;

FIG. 2 is a view illustrating appearances of a folded state of a foldable electronic device to which an outer case is attachable and detachable, according to an embodiment of the disclosure;

FIG. 3 is a perspective view illustrating an unfolded state of a combination of a foldable electronic device and an outer case, according to an embodiment of the disclosure;

FIG. 4 is a perspective view illustrating a closed state of a pen holder in a folded state of a combination of a foldable electronic device and an outer case, according to an embodiment of the disclosure;

FIG. 5 is a perspective view illustrating an open state of a pen holder in a folded state of a combination of a foldable electronic device and an outer case, according to an embodiment of the disclosure;

FIG. 6 is a perspective view illustrating a separated state of a pen holder in a folded state of a combination of a foldable electronic device and an outer case, according to an embodiment of the disclosure;

FIG. 7 is a perspective view illustrating a separated state of a pen holder to which a pen input device is attached in a folded state of a combination of a foldable electronic device and an outer case, according to an embodiment of the disclosure;

FIG. 8 is a partial cross-sectional view illustrating a combination of a foldable electronic device and an outer case, according to an embodiment of the disclosure;

FIG. 9 is a partial cross-sectional view illustrating an intermediate state of a combination of a foldable electronic device and an outer case, according to an embodiment of the disclosure;

FIG. 10 is a partial cross-sectional view illustrating a folded state of a combination of a foldable electronic device and an outer case, according to an embodiment of the disclosure; and

FIG. 11 is perspective views illustrating a state in which a pen input device is attached to a pen holder, according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

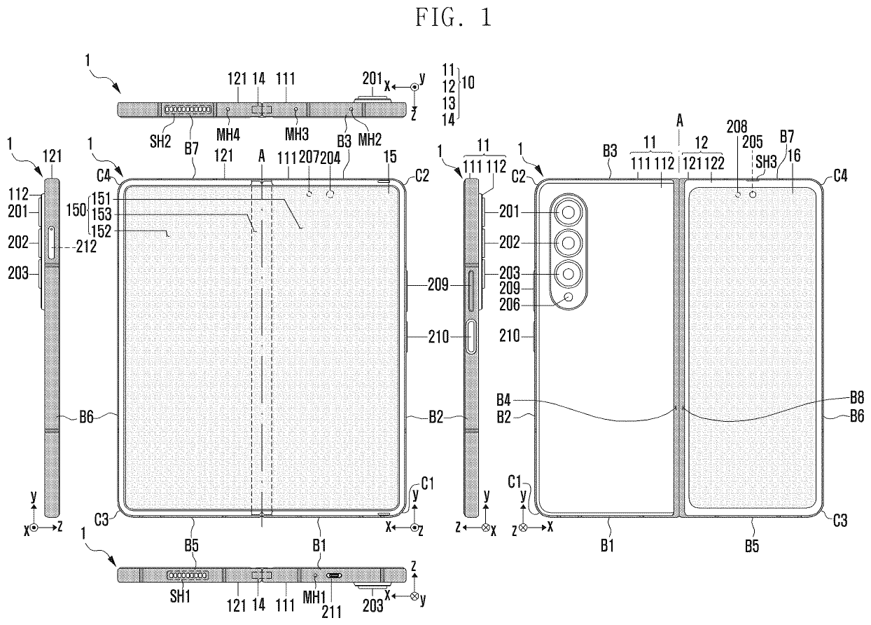

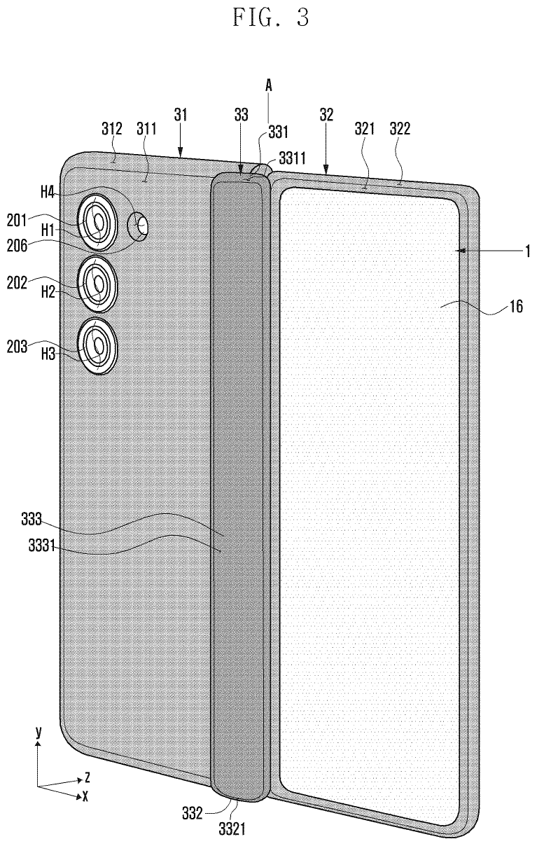

FIG. 1 is a view illustrating appearances of an unfolded state (also referred to as an unfolding state or a flat state) of a foldable electronic device 1 to which an outer case (e.g., the outer case 3 of FIG. 3) is attachable and detachable according to an embodiment of the disclosure.

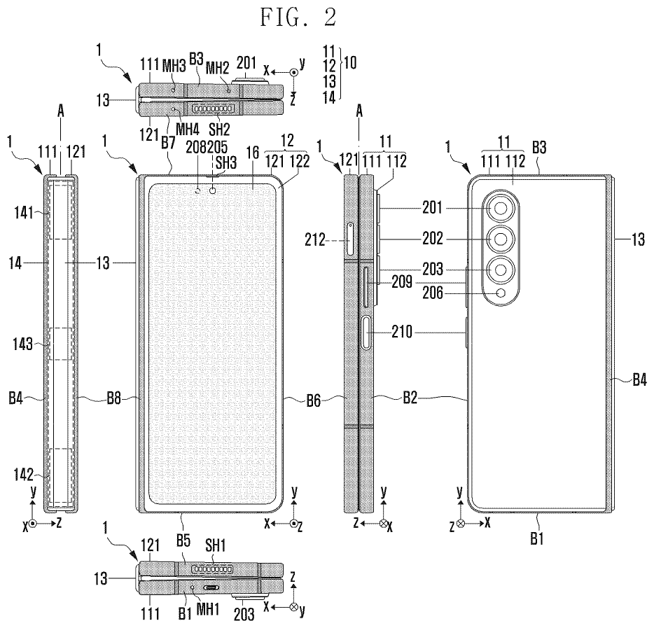

FIG. 2 is a view illustrating appearances of a folded state (also referred to as a folding state) of the foldable electronic device 1 to which the outer case is attachable and detachable according to an embodiment of the disclosure.

Referring to FIGS. 1 and 2, the foldable electronic device 1 may include a foldable housing 10, a first display module 15, a second display module 16, a first camera module 201, a second camera module 202, a third camera module 203, a fourth camera module 204, a fifth camera module 205, a light emitting module 206, a first sensor module 207, a second sensor module 208, a first sound input module (not separately illustrated), a second sound input module (not separately illustrated), a third sound input module (not separately illustrated), a fourth sound input module (not separately illustrated), a first sound output module (not separately illustrated), a second sound output module (not separately illustrated), a third sound output module (not separately illustrated), a key input module, a first connection terminal 211, and/or a second connection terminal 212.

According to an embodiment, an unfolded state and a folded state of the foldable electronic device 1 may be substantially provided by the foldable housing 10. An “unfolded state of the foldable electronic device 1” and an “unfolded state of the foldable housing 10” as described in the disclosure may be interpreted as being substantially identical. A “folded state of the foldable electronic device 1” and a “folded state of the foldable housing 10” as described in the disclosure may be interpreted as being substantially identical.

According to an embodiment, the foldable housing 10 may include a first housing (also referred to as a first housing part or a first housing structure) 11, a second housing (also referred to as a second housing part or a second housing structure) 12, a hinge housing 13, and/or a hinge part 14. The first housing 11 and the second housing 12 may be connected through the hinge part 14. The first housing 11 and the second housing 12 may be mutually rotatable with respect to the hinge part 14. The hinge part 14 may include, for example, one or more hinge modules (also referred to as hinge assemblies).

According to an embodiment, the first display module 15 may be disposed in the foldable housing 10. The first display module 15 may include, for example, a flexible display module (also referred to as a flexible display) or a foldable display module (also referred to as a foldable display), which may be transformed in response to switching between the unfolded state and the folded state of the foldable electronic device 1.

According to an embodiment, the first display module 15 may include a display area 150. The display area 150 may include an active area or a screen area capable of displaying an image based on an electrical signal. The display area 150 may include a first display area 151 corresponding to the first housing 11, a second display area 152 corresponding to the second housing 12, and a third display area 153 corresponding to the hinge part 14. The third display area 153 may extend the first display area 151 and the second display area 152.

According to an embodiment, the first display area 151 may be disposed in the first housing 11. A shape of the first display area 151 may be maintained by support of the first housing 11. For example, the first display area 151 may be supported by the first housing 11 and may be provided (or formed) substantially flat. In the specification, when a term “substantially” for limiting a structural part is used, an expression including a term “substantially” is understood or interpreted as a technical feature produced within a technical tolerance of a method used to manufacture the expression. Also, an including expression means that a specific effect or a result may be obtained within a specific tolerance, and a person skilled in the art knows a method of obtaining the tolerance.

According to an embodiment, the second display area 152 may be disposed in the second housing 12. A shape of the second display area 152 may be maintained by support of the second housing 12. For example, the second display area 152 may be supported by the second housing 12 and may be provided (or formed) substantially flat.

According to an embodiment, the third display area 153 may be positioned corresponding to hinge part 14. When the foldable electronic device 1 is switched between an unfolded state and a folded state, the third display area 153 may be transformed (or modified) corresponding to a relative position between the first display area 151 and the second display area 152. In the unfolded state of the foldable electronic device 1, the third display area 153 may be disposed substantially flat. In the folded state of the foldable electronic device 1, the third display area 153 may be disposed in a bended form. The unfolded state of the foldable electronic device 1 may be defined or interpreted as a state in which the third display area 153 is disposed flat. The folded state of the foldable electronic device 1 may be defined or interpreted as a state in which the third display area 153 is disposed in a bended form.

According to an embodiment, in the unfolded state of the foldable electronic device 1, the first display area 151 and the second display area 152 may form an angle of about 180 degrees, and the display area 150 may be provided (or disposed) substantially in a planar form. Due to a relative position between the first display area 151 disposed in the first housing 11 and the second display area 152 disposed in the second housing 12 in the unfolded state of the foldable electronic device 1, the third display area 153 may be disposed flat. In the unfolded state of the foldable electronic device 1, the third display area 153 may be pulled from both sides by the first display area 151 and the second display area 152, and a pulling force may be provided so as to reduce breakage of the third display area 153 while disposing the third display area 153 flat. The third display area 153 may be provided (or formed) with an extended width capable of being disposed flat while reducing stress by being pulled by the first display area 151 and the second display area 152 in the unfolded state of the foldable electronic device 1.

According to an embodiment, the first display 150 of the first display module 15 may substantially provide (or form) a front surface among an appearance of the foldable electronic device 1. The front surface of the foldable electronic device 1 may include a first front surface area provided (or formed) by the first display area 151, a second front surface area provided (or formed) by the second display area 152, and a third front surface area provided (or formed) by the third display area 153. The illustrated coordinate axes of the foldable electronic device 1 are, for example, illustrated with respect to the first housing 11, and a +z-axis direction may be defined or interpreted as a direction toward which a substantially flat first front surface area faces. For example, the first front surface area provided (or formed) by the first display area 151 may be substantially parallel to an x-y plane. In an unfolded state of the foldable electronic device 1, the front surface of the foldable electronic device 1 may be provided (or formed) substantially as a plane.

According to an embodiment, in the unfolded state of the foldable electronic device 1, the hinge part 14 may support the third display area 153 of the first display module 15 to be substantially flat. The hinge part 14 may, for example, reduce a crease phenomenon by supporting the third display area 153 so that the third display area 153 may be disposed flat without sagging or while reducing sagging in the unfolded state of the foldable electronic device 1.

According to an embodiment, in the unfolded state of the foldable electronic device 1, when an external force (e.g., an external pressure such as a touch input using a finger of a user or a touch input using an electronic pen) is applied to the third display area 153, the hinge part 14 may support the third display area 153 so that the third display area 153 may be maintained flat by reducing a sagging phenomenon of the third display area 153.

According to an embodiment, in the unfolded state of the foldable electronic device 1, when an external impact is applied due to a reason such as a dropping, the hinge part 14 may be configured to reduce or absorb the external impact so that an influence of the external impact on the third display area 153 may be reduced.

According to an embodiment, the foldable electronic device 1 may be implemented in an in-folding method in which the display area 150 of the first display module 15 (or the front surface of the foldable electronic device 1 in which the display area 150 is visually visible) may be folded inward. FIG. 2 illustrates a fully folded state of the foldable electronic device 1 in which the first housing 11 and the second housing 12 are disposed so that they cannot get any closer. In the fully folded state of the foldable electronic device 1, the first display area 151 and the second display area 152 (or, the first front surface area and the second front surface area) may face each other. For example, in the fully folded state of the foldable electronic device 1, an angle between the first housing 11 and the second housing 12 (or, an angle between the first display area 151 and the second display area 152, or an angle between the first front surface area and the second front surface area) may be about 0 degrees to about 10 degrees. In the fully folded state of the foldable electronic device 1, the display area 150 may not be substantially visible.

Although not separately illustrated, the foldable electronic device 1 may be disposed in an intermediate state between the unfolded state and the fully folded state. For example, in an intermediate state of the foldable electronic device 1 in which an angle between the first housing 11 and the second housing 12 is equal to or greater than a certain angle, the foldable electronic device 1 may be configured to provide a use environment in which a user may use the display area 150.

Hereinafter, in the disclosure, a “folded state of the foldable electronic device 1” may indicate the fully folded state contrasted with the intermediate state.

According to an embodiment, when viewing the unfolded state of the foldable electronic device 1, the display area 150 of the first display module 15 may be provided (or formed) in a symmetrical form with respect to a center line A of the foldable electronic device 1. The center line A of the foldable electronic device 1 may, when viewing the unfolded state of the foldable electronic device 1, correspond to a middle of an extended width of the third display area 153 from a first boundary between the first display area 151 and the third display area 153 to a second boundary between the second display area 152 and the third display area 153. An illustrated +x coordinate axis may, for example, be substantially parallel to the center line A, and an illustrated +y coordinate axis may be substantially perpendicular to the center line A.

According to various embodiments, the center line A of the foldable electronic device 1 may be defined or interpreted as a folding axis of the foldable housing 10 or the foldable electronic device 1. A folding axis may be substantially provided (or formed) by the hinge part 14.

According to an embodiment, in the folded state of the foldable electronic device 1, the third display area 153 disposed in a bended form may be provided (or formed) in a substantially symmetrical form with respect to the center line A of the foldable electronic device 1.

According to an embodiment, when viewing an unfolded state of the foldable electronic device 1, the display area 150 of the first display module 15 may be substantially rectangular.

According to an embodiment, the first housing 11 may include a first frame (also referred to as a first frame structure or a first framework) 111, and a first back cover 112 disposed (or coupled) in the first frame 111. A combination of the first frame 111 and the first back cover 112 may provide (or form) a first rear surface area and a first side surface area among an appearance of the foldable electronic device 1. The first frame 111 may provide (or form) at least a part of the first side surface area of the foldable electronic device 1. The first back cover 112 may provide (or form) at least a part of the first rear surface area of the foldable electronic device 1. The first rear surface area may face in an opposite direction to a first front surface area of the foldable electronic device 1 provided (or formed) by the first display area 151 of the first display module 15.

According to an embodiment, the first frame 111 may include a first side (also referred to as a first lateral member, a first side surface structure, or a first side surface bezel structure) 1112. The first side 1112 may at least partly surround a space between the first display area 151 and the first back cover 112, and may provide (or form) at least a part of the first side surface area among an appearance of the foldable electronic device 1.

According to an embodiment, the first frame 111 may include a first support plate (not separately illustrated) extending from the first side 1112 or connected to the first side 1112. The first support plate may be a structural element positioned inside the foldable electronic device 1 corresponding to the first housing 11.

According to an embodiment, the first frame 111 may be provided (or formed) as an integrated or single structure including the first support plate and the first side 1112 (e.g., a single continuous structure or a complete structure).

According to an embodiment, the first support plate may be at least partly positioned between the first display area 151 and the first back cover 112. The first display area 151 may be disposed in the first support plate, and the first support plate may support the first display area 151.

According to an embodiment, various electrical constituent elements (not separately illustrated) such as a first printed circuit board or a first battery may be at least partly disposed in the first support plate of the first frame 111 between the first frame 111 and the first back cover 112.

According to an embodiment, the second housing 12 may include a second frame (also referred to as a second frame structure or a second framework) 121, and/or a second back cover 122 disposed in the second frame 121. A combination of the second frame 121 and the second back cover 122 may provide (or form) a second rear surface area and a second side surface area among an appearance of the foldable electronic device 1. The second frame 121 may provide (or form) at least a part of the second side surface area of the foldable electronic device 1. The second back cover 122 may provide (or form) at least a part of the second rear surface area of the foldable electronic device 1. The second rear surface area may face in an opposite direction to a second front surface area of the foldable electronic device 1 provided (or formed) by the second display area 152.

According to an embodiment, the second frame 121 may include a second side (also referred to as a second lateral member, a second side surface structure, or a second side surface bezel structure) 1212. The second side 1212 may at least partly surround a space between the second display area 152 and the second back cover 122, and may provide (or form) at least a part of the second side surface area among an appearance of the foldable electronic device 1.

According to an embodiment, the second frame 121 may include a second support plate (not separately illustrated) extending from the second side 1212 or connected to the second side 1212. The second support plate may be a structural element positioned inside the foldable electronic device 1 corresponding to the second housing 12.

According to an embodiment, the second frame 121 may be provided as an integrated or single structure including the second support plate and the second side 1212 (e.g., a single continuous structure or a complete structure).

According to an embodiment, the second support plate may be at least partly positioned between the second display area 152 and the second back cover 122. The second display area 152 may be disposed in the second support plate, and the second support plate may support the second display area 152.

According to an embodiment, various electrical constituent elements (not separately illustrated) such as a second printed circuit board or a second battery may be at least partly disposed in the second support plate of the second frame 121 between the second frame 121 and the second back cover 122.

According to an embodiment, the first side 1112 of the first frame 111 may include a first side surface part B1, a second side surface part B2, a third side surface part B3, and/or a fourth side surface part B4. The first side surface part B1 may extend in a direction perpendicular to the center line A of the foldable electronic device 1. The third side surface part B3 may be spaced apart from the first side surface part B1 in a direction of the center line A of the foldable electronic device 1, and may be substantially parallel to the first side surface part B1. The second side surface part B2 may extend or connect one end portion of the first side surface part B1 and one end portion of the third side surface part B3. The fourth side surface part B4 may extend or connect the other end portion of the first side surface part B1 and the other end portion of the third side surface part B3. The second side surface part B2 and the fourth side surface part B4 may be substantially parallel. The fourth side surface part B4 may be positioned closer to the center line A of the foldable electronic device 1 than the second side surface part B2.

According to an embodiment, a first corner C1 in which the first side surface part B1 and the second side surface part B2 are extended or connected, and/or a second corner C2 in which the second side surface part B2 and the third side surface part B3 are extended or connected, may be provided (or formed) in a smooth curved shape.

According to an embodiment, when viewed from above the first back cover 112, the first side surface part B1, the second side surface part B2, the third side surface part B3, and the fourth side surface part B4 may surround the first back cover 112.

According to an embodiment, the second side 1212 of the second frame 121 may include a fifth side surface part B5, a sixth side surface part B6, a seventh side surface part B7, and/or an eighth side surface part B8. The fifth side surface part B5 may extend in a direction perpendicular to the center line A of the foldable electronic device 1. The seventh side surface part B7 may be spaced apart from the fifth side surface part B5 in the direction of the center line A of the foldable electronic device 1, and may be substantially parallel to the fifth side surface part B5. The sixth side surface part B6 may extend or connect one end portion of the fifth side surface part B5 and one end portion of the seventh side surface part B7. The eighth side surface part B8 may extend or connect the other end portion of the fifth side surface part B5 and the other end portion of the seventh side surface part B7. The sixth side surface part B6 and the eighth side surface part B8 may be substantially parallel. The eighth side surface part B8 may be positioned closer to the center line A of the foldable electronic device 1 than the sixth side surface part B6.

According to an embodiment, a third corner C3 in which the fifth side surface part B5 and the sixth side surface part B6 are extended or connected, and/or a fourth corner C4 in which the sixth side surface part B6 and the seventh side surface part B7 are extended or connected, may be provided (or formed) in a smooth curved shape.

According to an embodiment, when viewed from above the second back cover 122, the fifth side surface part B5, the sixth side surface part B6, the seventh side surface part B7, and the eighth side surface part B8 may surround the second back cover 122.

According to an embodiment, in the folded state of the foldable electronic device 1, the first side 1112 of the first frame 111 and the second side 1212 of the second frame 121 may be aligned and overlapped. In the folded state of the foldable electronic device 1, the first side surface part B1 and the fifth side surface part B5 may be aligned and overlapped. In the folded state of the foldable electronic device 1, the second side surface part B2 and the sixth side surface part B6 may be aligned and overlapped. In the folded state of the foldable electronic device 1, the third side surface part B3 and the seventh side surface part B7 may be aligned and overlapped.

According to an embodiment, the first side surface part B1, the third side surface part B3, and the fourth side surface part B4 may be one side bezel (or a screen bezel) surrounding one side area of the first display module 15 with respect to the center line A of the foldable electronic device 1. The fifth side surface part B5, the seventh side surface part B7, and the eighth side surface part B8 may be the other side bezel (or the screen bezel) surrounding the other side area of the first display module 15 with respect to the center line A of the foldable electronic device 1.

According to an embodiment, the fourth side surface part B4 and the eighth side surface part B8 may be positioned on an opposite side of the third display area 153. When viewed from above the front surface of the foldable electronic device 1 in the unfolded state, the fourth side surface part B4 and the eighth side surface part B8 may not be visible.

According to an embodiment, a hinge housing (also referred to as a hinge cover) 13 may be connected to one or more hinge modules included in the hinge part 14 (e.g., a first hinge module 141, a second hinge module 142, and a third hinge module 143).

According to an embodiment, when the foldable electronic device 1 is switched from the unfolded state to the folded state, due to a change in a relative position between the first frame 111 and the second frame 121 connected through the hinge part 14, and a change in a state of the hinge part 14 coupled with the hinge housing 13, a gap between the first frame 111 and the second frame 121 may be opened on an opposite side of the third display area 153. The hinge housing 13 may be exposed to outside through the opened gap. For example, in the folded state of the foldable electronic device 1, the hinge housing 13 may be exposed to outside through the opened gap between the fourth side surface part B4 of the first frame 111 and the eighth side surface part B8 of the second frame 121. Depending on an angle between the first frame 111 and the second frame 121, a width of the gap between the fourth side surface part B4 of the first frame 111 and the eighth side surface part B8 of the second frame 121 may vary. The hinge housing 13 may be more exposed to outside in the folded state of the foldable electronic device 1 than in an intermediate state of the foldable electronic device 1. In the folded state of the foldable electronic device 1, the hinge housing 13 may be a part of the appearance that covers an inside of the foldable electronic device 1. In the folded state of the foldable electronic device 1, a side surface of the foldable electronic device 1 may include a first side surface area provided by the first side 1112 of the first frame 111, a second side surface area provided by the second side 1212 of the second frame 121, and a third side surface area provided by the hinge housing 13.

According to an embodiment, when the foldable electronic device 1 is switched from the folded state to the unfolded state, due to the change in the relative position between the first frame 111 and the second frame 121 connected through the hinge part 14, and the change in the state of the hinge part 14 coupled with the hinge housing 13, the gap between the first frame 111 and the second frame 121 may be closed on the opposite side of the third display area 153. For example, in the unfolded state of the foldable electronic device 1, the gap between the fourth side surface part B4 of the first frame 111 and the eighth side surface part B8 of the second frame 121 may be closed, and the hinge housing 13 may not be exposed to the outside.

According to an embodiment, the second display module 16 (also referred to as a second display) may be positioned between the second back cover 122 and the second support plate of the second frame 121. The second display module 16 may be disposed or coupled in the second back cover 122 and/or the second support plate. A display area of the second display module 16 may be visually visible through the second back cover 122.

According to an embodiment, the foldable electronic device 1 may be configured to display an image through the second display module 16 instead of the first display module 15 in the folded state.

According to an embodiment, the first camera module 201, the second camera module 202, the third camera module 203, the fourth camera module 204, and/or the fifth camera module 205 may include one or more lenses, image sensor(s), and/or an image signal processor (image signal processor (ISP)).

According to an embodiment, the first camera module 201, the second camera module 202, and the third camera module 203 may be accommodated in the first housing 11 corresponding to the first back cover 112 (or, a first rear surface area of the foldable electronic device 1). For example, the first back cover 112 may include a first camera hole (or a first light transmission area) corresponding to the first camera module 201, a second camera hole (or a second light transmission area) corresponding to the second camera module 202, and/or a third camera hole (or a third light transmission area) corresponding to the third camera module 203. A position or a number of camera modules accommodated in the first housing 11 corresponding to the first back cover 112 is not limited to an illustrated example and may vary.

According to an embodiment, the first camera module 201 (also referred to as a first camera, a first rear surface camera module, or a first rear surface camera), the second camera module 202 (also referred to as a second camera, a second rear surface camera module, or a second rear surface camera), or the third camera module 203 (also referred to as a third camera, a third rear surface camera module, or a third rear surface camera) may include a wide-angle camera module, a telephoto camera module, a color camera module, a monochrome camera module, or an IR camera (e.g., a time of flight (TOF) camera, a structured light camera) module.

According to an embodiment, the first camera module 201, the second camera module 202, and the third camera module 203 may have different attributes (e.g., angles of view) or functions.

According to various embodiments, the first camera module 201, the second camera module 202, or the third camera module 203 may provide different angles of view (or lenses of different angles of view). The foldable electronic device 1 may selectively use an angle of view of the first camera module 201, the second camera module 202, or the third camera module 203 based on a user's selection regarding an angle of view.

According to an embodiment, the fourth camera module 204 may be accommodated in the first housing 11 corresponding to a first front surface area of the foldable electronic device 1.

According to an embodiment, the fourth camera module 204 (also referred to as a fourth camera, a first front surface camera module, or a first front surface camera) may overlap the first display area 151 of the first display module 15 when viewed from above the first front surface area of the foldable electronic device 1. The fourth camera module 204 may be positioned on a rear surface of the first display area 151 or below the first display area 151. When viewed from outside of the foldable electronic device 1, the fourth camera module 204, or a position of the fourth camera module 204, may not be substantially visually distinguished (or exposed). The fourth camera module 204 may include, for example, a hidden display rear surface camera (e.g., under display camera (UDC)). External light may pass through the first display module 15 and may reach the fourth camera module 204.

According to an embodiment, the fifth camera module 205 may be accommodated in the second housing 12 corresponding to the second back cover 122 (or, a second rear surface area of the foldable electronic device 1).

According to an embodiment, the fifth camera module 205 may be located aligned with an opening provided in the second display module 16 or may be at least partly inserted into the opening. External light may pass through the second back cover 122 and the opening provided in the second display module 16 and may reach the fifth camera module 205. The opening of the second display module 16 aligned or overlapped with the fifth camera module 205 may be a through hole. In various embodiments, the opening of the second display module 16 aligned or overlapped with the fifth camera module 205 may be provided as a notch (not separately illustrated).

According to various embodiments, the fifth camera module 205 (also referred to as a fifth camera, a second front surface camera module, or a second front surface camera) may overlap the second display module 16 when viewed from above the second rear surface area of the foldable electronic device 1. The fifth camera module 205 may be positioned on a rear surface of the second display module 16 or below the second display module 16. When viewed from outside of the foldable electronic device 1, the fifth camera module 205, or a location of the fifth camera module 205, may not be substantially visually distinguished (or exposed). The fifth camera module 205 may include, for example, a hidden display rear surface camera (e.g., UDC). External light may pass through the second back cover 122 and the second display module 16 and may reach the fifth camera module 205.

According to an embodiment, the light emitting module 206 may be accommodated in the first housing 11 corresponding to the first back cover 112 (or, a first rear surface area of the foldable electronic device 1). The first back cover 112 may include a flash hole (or a fourth light transmission area) corresponding to the light emitting module 206. The light emitting module 206 may include, for example, a light emitting diode (LED) or a xenon lamp. The light emitting module 206 may include a light source for the first camera module 201, the second camera module 202, and/or the third camera module 203.

According to an embodiment, the first sensor module 207 may be accommodated in the foldable housing 10 corresponding to the front surface of the foldable electronic device 1.

According to an embodiment, the first sensor module 207 may include an optical sensor module. The optical sensor module may include, for example, a proximity sensor module or an illuminance sensor module.

According to an embodiment, the first sensor module 207 may overlap the first display area 151 of the first display module 15 when viewed from above the first front surface area of the foldable electronic device 1. The first sensor module 207 may be positioned on a rear surface of the first display area 151 or below the first display area 151. When viewed from outside of the foldable electronic device 1, the first sensor module 207, or a position of the first sensor module 207, may not be substantially visually distinguished (or exposed). External light may pass through the first display module 15 and may reach the first sensor module 207.

According to an embodiment, the second sensor module 208 may be accommodated in the foldable housing 10 corresponding to the rear surface of the foldable electronic device 1. The second sensor module 208 may include an optical sensor module. The optical sensor module may include, for example, a proximity sensor module or an illuminance sensor module. The second sensor module 208 may be positioned on a rear surface of the second display module 16 or below the second display module 16. When viewed from outside of the foldable electronic device 1, the second sensor module 208, or a position of the second sensor module 208, may not be substantially visually distinguished (or exposed). External light may pass through the second display module 16 and may reach the second sensor module 208.

According to various embodiments, the foldable electronic device 1 may further include various other sensor module(s) (e.g., a biometric sensor module) (not separately illustrated).

According to an embodiment, the first sound input module may include a first microphone (also referred to as a first mic) (not separately illustrated). The second sound input module may include a second microphone (also referred to as a second mic) (not separately illustrated). The third sound input module may include a third microphone (also referred to as a third mic) (not separately illustrated). The fourth sound input module may include a fourth microphone (also referred to as a fourth mic) (not separately illustrated). The first microphone may be accommodated in the first housing 11 corresponding to a first mic hole MH1 included in the first side surface part B1 of the first side 1112, for example. The second microphone may be accommodated in the first housing 11 corresponding to a second mic hole MH2 included in the third side surface part B3 of the first side 1112, for example. The third microphone may be accommodated in the first housing 11 corresponding to a third mic hole MH3 included in the third side surface part B3 of the first side 1112, for example. The fourth microphone may be accommodated in the second housing 12 corresponding to a fourth mic hole MH4 included in the seventh side surface part B7 of the second side 1212, for example. A position or the number of microphones and mic holes corresponding to microphones is not limited to an illustrated example and may vary.

According to an embodiment, the first sound output module may include a first speaker (not separately illustrated). The second sound output module may include a second speaker (not separately illustrated). The first speaker or the second speaker may be a speaker for multimedia playback or for playback of recorded audio. The first speaker may be accommodated in the second housing 12 corresponding to a first speaker hole SH1 included in the second side 1212, for example. The second speaker may be accommodated in the second housing 12 corresponding to a second speaker hole SH2 provided in the second side 1212, for example. A position or the number of speakers for multimedia playback or for playback of recorded audio and speaker holes corresponding to the speaker is not limited to an illustrated example and may vary.

According to an embodiment, the third sound output module may include a third speaker (not separately illustrated). The third speaker may include a receiver for a call. The third speaker may be accommodated in the second housing 12 corresponding to a third speaker hole SH3 provided between the second back cover 122 and the seventh side surface part B7 of the second side 1212, for example. A position or the number of speakers for a call and speaker holes corresponding to the speaker is not limited to an illustrated example and may vary.

According to an embodiment, the key input module may include a first key (also referred to as a first side key) 209, a second key (also referred to as a second side key) 210, and/or a key signal generator (not separately illustrated). For example, the first key 209 may be positioned in a first key hole included in the first side 1112, the second side surface part B2, and the second key 210 may be positioned in a second key hole included in the first side 1112, the second side surface part B2. The key signal generator may be configured to generate a first key signal corresponding to a press or a touch on the first key 209, and a second key signal corresponding to a press or a touch on the second key 210. A position or the number of the key input modules is not limited to an illustrated example and may vary.

According to an embodiment, the first connection terminal 211 (also referred to as a first connector or a first interface terminal) may be accommodated in the first housing 11 corresponding to a first connection terminal hole (e.g., a first connector hole) included in the first side surface part B1 of the first side 1112. The foldable electronic device 1 may transmit and/or receive power and/or data with an external electronic device electrically connected with the first connection terminal 211. The first connection terminal 211 may include, for example, a USB connector or a high definition multimedia interface (HDMI) connector. A position of the first connection terminal 211 and a position of a first connection terminal hole corresponding to the first connection terminal 211 are not limited to an illustrated example and may vary.

According to an embodiment, the second connection terminal (also referred to as a second connector or a second interface terminal) 212 may be accommodated in the second housing 12 corresponding to a second connection terminal hole (e.g., a second connector hole) included in the sixth side surface part B6 of the second side 1212. An external storage medium such as an secure digital memory (SD) card, a subscriber identification module (SIM) card, or a universal SIM (USIM) may be connected to the second connection terminal 212. A position of the second connection terminal 212 and a position of a second connection terminal hole corresponding to the second connection terminal 212 are not limited to an illustrated example and may vary.

The foldable electronic device 1 may further include various constituent elements depending on a provided configuration. The constituent elements have various modifications according to a convergence trend of the foldable electronic device 1 and thus may not be all listed, but a constituent element at an equivalent level to the above-mentioned constituent elements may be additionally further included in the foldable electronic device 1. In various embodiments, depending on the provided configuration, some constituent element(s) among the above constituent element(s) may be excluded or may be replaced with another constituent element.

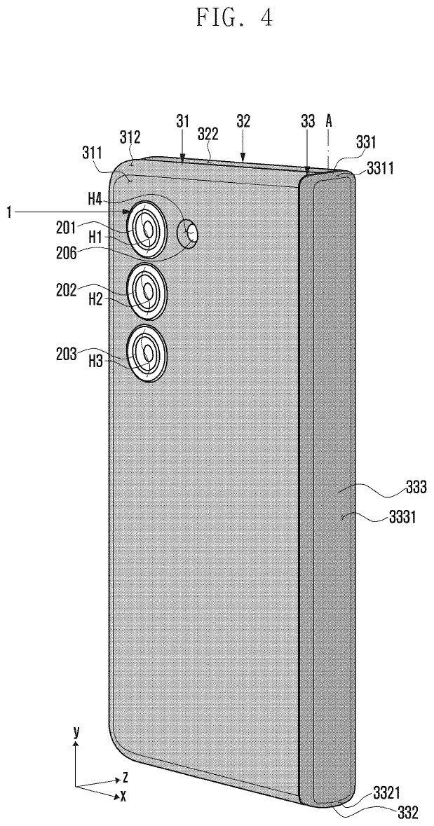

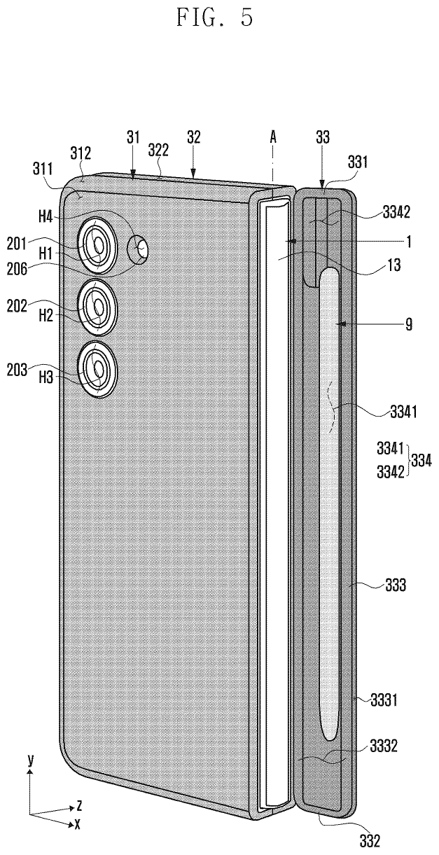

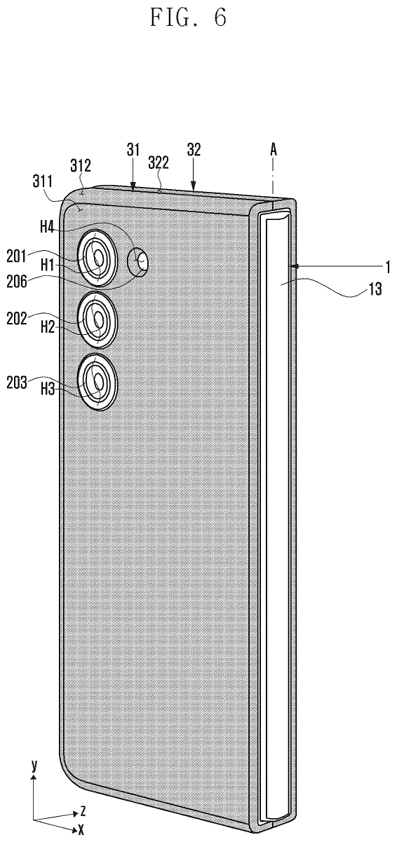

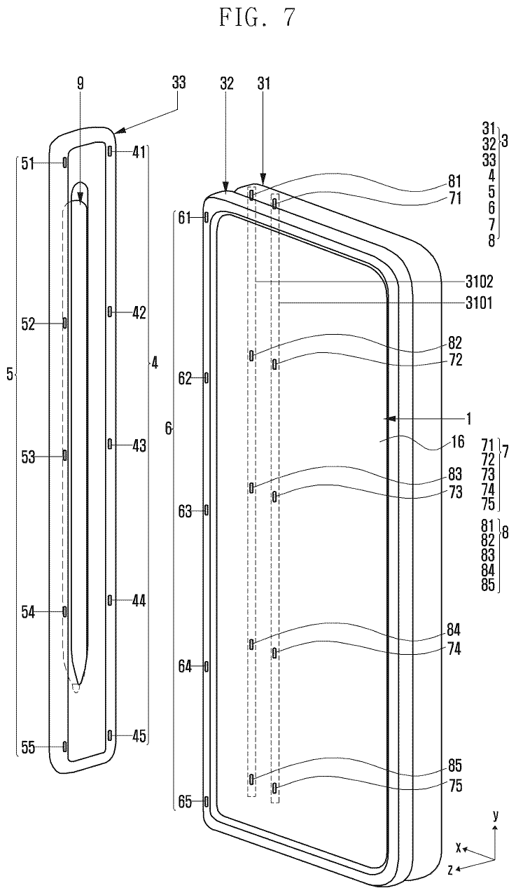

FIG. 3 is a perspective view illustrating an unfolded state of a combination of the foldable electronic device 1 and the outer case 3, according to an embodiment of the disclosure. FIG. 4 is a perspective view illustrating a closed state of a pen holder 33 in a folded state of a combination of the foldable electronic device 1 and the outer case 3, according to an embodiment of the disclosure. FIG. 5 is a perspective view illustrating an open state of the pen holder 33 in the folded state of the combination of the foldable electronic device 1 and the outer case 3, according to an embodiment of the disclosure. FIG. 6 is a perspective view illustrating a separated state of the pen holder 33 in the folded state of the combination of the foldable electronic device 1 and the outer case 3, according to an embodiment of the disclosure. FIG. 7 is a perspective view illustrating a separated state of the pen holder 33 to which a pen input device 9 is attached in the folded state of the combination of the foldable electronic device 1 and the outer case 3, according to an embodiment of the disclosure.

According to an embodiment, an unfolded state, a folded state, and an intermediate state of the combination of the foldable electronic device 1 and the outer case 3 are substantially provided by the foldable electronic device 1. Hereinafter, an “unfolded state of the combination of the foldable electronic device 1 and the outer case 3” may be defined or interpreted as being substantially identical to an “unfolded state of the foldable electronic device 1.” Hereinafter, a “folded state of the combination of the foldable electronic device 1 and the outer case 3” may be defined or interpreted as being substantially identical to a “folded state of the foldable electronic device 1.” Hereinafter, an “intermediate state of the combination of the foldable electronic device 1 and the outer case 3” may be defined or interpreted as being substantially identical to an “intermediate state of the foldable electronic device 1.”

Referring to FIGS. 3, 4, 5, 6, and 7, the outer case 3 may include a first case (also referred to as a first cover) 31, a second case (also referred to as a second cover) 32, a pen holder (also referred to as a pen support member or a pen support part) 33, a plurality of first magnets 4, a plurality of second magnets 5, a plurality of third magnets 6, a plurality of fourth magnets 7, and/or a plurality of fifth magnets 8.

According to an embodiment, the first case 31 may be configured to be attachable and detachable to the first housing 11 of the foldable electronic device 1.

According to an embodiment, the first case 31 may include a first cover area 311 and a second cover area 312 extending from the first cover area 311. The first cover area 311 may be configured to at least partly cover the first back cover 112 (with reference to FIG. 1) included in the first housing 11 of the foldable electronic device 1. The second cover area 312 may be configured to at least partly cover the first side 1112 (with reference to FIG. 1) included in the first housing 11 of the foldable electronic device 1. The second cover area 312 may, for example, extend in a looped form (or configuration) along the first side 1112 (with reference to FIG. 1) of the first housing 11.

According to an embodiment, the first case 31 may be provided (or formed) as an integrated or single structure including the first cover area 311 and the second cover area 312 (e.g., a single continuous structure or a complete structure).

According to an embodiment, the first case 31 may include a first recess (not separately illustrated) for receiving and holding the first housing 11 (with reference to FIG. 1) of the foldable electronic device 1 by a combination of the first cover area 311 and the second cover area 312.

According to an embodiment, the second cover area 312 of the first case 31, or a combination of the first and second cover areas 311 and 312 of the first case 31, may provide an elastic structure in which the first case 31 may be elastically coupled with the first housing 11 (with reference to FIG. 1) of the foldable electronic device 1. When the first housing 11 of the foldable electronic device 1 is disposed in the first recess of the first case 31, the first case 31 may elastically press the first housing 11 and may be stably coupled with the first housing 11 while reducing shaking or looseness.

According to an embodiment, the first case 31 may be configured not to cover the display area 150 (with reference to FIG. 1) of the first display module 15 included in the foldable electronic device 1.

According to an embodiment, the first cover area 311 of the first case 31 may include a first opening H1 exposing the first camera module 201 to the outside. The first cover area 311 of the first case 31 may include a second opening H2 exposing the second camera module 202 to the outside. The first cover area 311 of the first case 31 may include a third opening H3 exposing the third camera module 203 to the outside.

According to various embodiments, the first cover area 311 of the first case 31 may be implemented to have a single opening (not separately illustrated) replacing the first opening H1, the second opening H2, and the third opening H3.

According to an embodiment, the first cover area 311 included in the first case 31 may include a fourth opening H4 exposing the light emitting module 206 to the outside.

According to various embodiments, the first cover area 311 of the first case 31 may be implemented to have a single opening (not separately illustrated) replacing the first opening H1, the second opening H2, the third opening H3, and the fourth opening H4.

According to an embodiment, the second cover area 312 of the first case 31 may include a fifth opening (not separately illustrated) exposing a first mic hole MH1 (with reference to FIG. 1) of the foldable electronic device 1 to the outside.

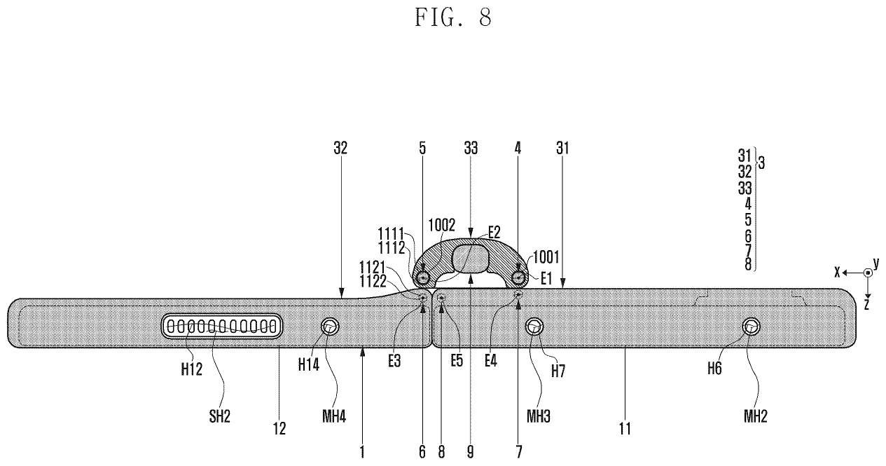

According to an embodiment, the second cover area 312 of the first case 31 may include a sixth opening H6 (with reference to FIG. 8) exposing a second mic hole MH2 (with reference to FIG. 1) of the foldable electronic device 1 to the outside.

According to an embodiment, the second cover area 312 of the first case 31 may include a seventh opening H7 (with reference to FIG. 8) exposing a third mic hole MH3 of the foldable electronic device 1 to the outside.

According to an embodiment, the second cover area 312 of the first case 31 may include an eighth opening (not separately illustrated) exposing a first key 209 (with reference to FIG. 1) of the foldable electronic device 1 to the outside. The second cover area 312 of the first case 31 may include a ninth opening (not separately illustrated) exposing a second key 210 (with reference to FIG. 1) of the foldable electronic device 1 to the outside. In various embodiments, the second cover area 312 of the first case 31 may be implemented to have a single opening replacing the eighth opening and the ninth opening.

According to an embodiment, the second cover area 312 of the first case 31 may include a tenth opening (not separately illustrated) exposing the first connection terminal 211 (with reference to FIG. 1) of the foldable electronic device 1 to the outside.

According to an embodiment, the first case 31 may be formed of a non-conductive material (e.g., a polymer).

According to an embodiment, the second case 32 may be configured to be attachable and detachable to the second housing 12 of the foldable electronic device 1.

According to an embodiment, the second case 32 may include a third cover area 321 and a fourth cover area 322 extending from the third cover area 321. The third cover area 321 may be configured to cover, when viewed from above a display area of the second display module 16, a portion between the second side 1212 (with reference to FIG. 1) and the display area of the second display module 16 among the second back cover 122 (with reference to FIG. 1). The fourth cover area 322 may be configured to at least partly cover the second side 1212 (with reference to FIG. 1) included in the second housing 12 of the foldable electronic device 1. The fourth cover area 322 may, for example, extend in a looped form along the second side 1212 of the second housing 12.

According to an embodiment, the second case 32 may be provided (or formed) as an integrated or single structure including the third cover area 321 and the fourth cover area 322 (e.g., a single continuous structure or a complete structure).

According to an embodiment, the second case 32 may include a second recess (not separately illustrated) for receiving and holding the second housing 12 (with reference to FIG. 1) of the foldable electronic device 1 by a combination of the third cover area 321 and the fourth cover area 322.

According to an embodiment, the fourth cover area 322 of the second case 32, or a combination of the third cover area 321 and the fourth cover area 322 of the second case 32, may provide an elastic structure in which the second case 32 may be elastically coupled with the second housing 12 (with reference to FIG. 1) of the foldable electronic device 1. When the second housing 12 of the foldable electronic device 1 is disposed in the second recess of the second case 32, the second case 32 may elastically press the second housing 12 and may be stably coupled with the second housing 12 while reducing shaking or looseness.

According to an embodiment, the second case 32 may be configured not to cover the display area 150 of the first display module 15 included in the foldable electronic device 1. The second case 32 may be configured not to cover a display area of the second display module 16 included in the foldable electronic device 1.

According to various embodiments, the second case 32 may include an eleventh opening (not separately illustrated) exposing a first speaker hole SH1 (with reference to FIG. 1) of the foldable electronic device 1 to the outside.

According to an embodiment, the second case 32 may include a twelfth opening H12 (with reference to FIG. 8) exposing a second speaker hole SH2 (with reference to FIG. 8) of the foldable electronic device 1 to the outside.

According to an embodiment, the second case 32 may include a thirteenth opening (not separately illustrated) exposing the second connection terminal 212 (with reference to FIG. 1) of the foldable electronic device 1 to the outside.

According to an embodiment, the second case 32 may include a fourteenth opening H14 (with reference to FIG. 8) exposing a fourth mic hole MH4 (with reference to FIG. 8) of the foldable electronic device 1 to the outside.

According to an embodiment, the second case 32 may be formed of a non-conductive material (e.g., a polymer).

According to an embodiment, the pen holder 33 may be configured to cover the hinge housing 13 of the foldable electronic device 1 in the folded state or an intermediate state of the foldable electronic device 1.

According to an embodiment, the pen holder 33 may include a first side wall 331, a second side wall 332, and a side wall extension part 333. The first side wall 331 and the second side wall 332 may be positioned on opposite sides to each other in a direction of a center line (or a folding axis) A of the foldable electronic device 1. The first side wall 331 may provide (or form) a first surface (also referred to as a first bottom surface) 3311 of the pen holder 33. The second side wall 332 may provide (or form) a second surface (also referred to as a second bottom surface) 3321 of the pen holder 33. The first surface 3311 may face in a first direction substantially parallel to the center line A of the foldable electronic device 1, and the second surface 3321 may face in a second direction opposite to the first direction. The first surface 3311 and the second surface 3321 may be provided (or formed) substantially symmetrically with each other. The side wall extension part 333 may extend or connect the first side wall 331 and the second side wall 332 between the first side wall 331 and the second side wall 332. The side wall extension part 333 may, for example, extend substantially straight from the first side wall 331 to the second side wall 332 in a direction of the center line A of the foldable electronic device 1.

According to an embodiment, the side wall extension part 333 of the pen holder 33 may provide (or form) first and second lateral surfaces 3331 and 3332 of the pen holder 33 connecting the first surface 3311 of the first side wall 331 and the second surface 3321 of the second side wall 332. For example, when viewed in a cross-section perpendicular to the center line A (with reference to FIG. 1) of the foldable electronic device 1, the first lateral surface 3331 may be provided as a symmetrical curved surface form with respect to the center line A. For example, when viewed in a cross-section perpendicular to the center line A of the foldable electronic device 1, the second lateral surface 3332 of the pen holder 33 may face in a direction substantially perpendicular to the center line A. When viewing a state in which the pen holder 33 is attached to the first and second cases 31 and 32 (with reference to FIG. 3 or 4), the first surface 3311, the second surface 3321, and the first lateral surface 3331 may be exposed to the outside, and the second lateral surface 3332 may be covered.

According to an embodiment, the pen holder 33 may be provided (or formed) as an integrated or single structure including the first side wall 331, the second side wall 332, and the side wall extension part 333 (e.g., a single continuous structure or a complete structure).

According to an embodiment, the pen holder 33 may be provided (or formed) in a substantially symmetrical form with respect to the center line A of the foldable electronic device 1.

According to an embodiment, the pen holder 33 may be formed of a non-conductive material (e.g., a polymer).

According to an embodiment, the side wall extension part 333 of the pen holder 33 may include a third recess 334 (with reference to FIG. 5) configured to accommodate a pen input device (also referred to as a pen or an electronic pen) (e.g., a stylus or a stylus pen) 9. The third recess 334 may include an indented-form groove formed in the second lateral surface 3332 of the side wall extension part 333.

According to an embodiment, the third recess 334 of the pen holder 33 may include a first partial recess 3341 and a second partial recess 3342. The first partial recess 3341 and the second partial recess 3342 may be disposed in a direction of the center line A of the foldable electronic device 1. The first partial recess 3341 may be configured, for example, such that a portion of the pen input device 9 (e.g., a pen tip and a first section extending from the pen tip) may be snap-fitted. The second partial recess 3342 may provide a space in which a user may pull and separate a remaining portion of the pen input device 9 (e.g., a second section extending from the first section to an end portion opposite to the pen tip) from the pen holder 33.

According to an embodiment, the pen holder 33 may be configured to be connected to the first case 31 and the second case 32 through a magnetic force.

According to an embodiment, the plurality of first magnets 4 and the plurality of second magnets 5 may be disposed in the pen holder 33.

According to an embodiment, the plurality of first magnets 4 and the plurality of second magnets 5 included in the pen holder 33 may be provided substantially symmetrically. As in an illustrated example, the pen holder 33 may be attached to the second case 32 through an attractive force (or attraction) between the plurality of second magnets 5 and the second case 32. When the pen holder 33 is attached to the second case 32 through the attractive force between the plurality of second magnets 5 and the second case 32, the first surface 3311 of the pen holder 33 may face in a direction in which the third and seventh side surface parts B3 and B7 (with reference to FIG. 1) of the foldable electronic device 1 face, and the second surface 3321 of the pen holder 33 may face in a direction in which the first and fifth side surface parts B1 and B5 (with reference to FIG. 1) of the foldable electronic device 1 face. Although not separately illustrated, the pen holder 33 may also be attached to the second case 32 through an attractive force between the plurality of first magnets 4 and the second case 32. When the pen holder 33 is attached to the second case 32 through the attractive force between the plurality of first magnets 4 and the second case 32, the first surface 3311 of the pen holder 33 may face in the direction in which the first and fifth side surface parts B1 and B5 (with reference to FIG. 1) of the foldable electronic device 1 face, and the second surface 3321 of the pen holder 33 may face in the direction in which the third and seventh side surface parts B3 and B7 (with reference to FIG. 1) of the foldable electronic device 1 face.

According to an embodiment, the plurality of first magnets 4 and the plurality of second magnets 5 may be disposed in the side wall extension part 333 of the pen holder 33. The plurality of first magnets 4 and the plurality of second magnets 5 may be positioned on opposite sides with the third recess 334 of the side wall extension part 333 interposed therebetween. The plurality of first magnets 4 and the plurality of second magnets 5 may be positioned adjacent to the second lateral surface 3332 of the pen holder 33. A portion of the pen holder 33 in which the plurality of first magnets 4 is disposed or included may be referred to as one end, one end portion, or a first portion of the pen holder 33. A portion of the pen holder 33 in which the plurality of second magnets 5 is disposed or included may be referred to as the other end, the other end portion, or a second portion of the pen holder 33.

According to an embodiment, the plurality of first magnets 4 and the plurality of second magnets 5 may be disposed inside the side wall extension part 333 of the pen holder 33 and may not be exposed to the outside.

According to an embodiment, the plurality of first magnets 4 may be disposed spaced apart from each other in the direction of the center line A of the foldable electronic device 1. The plurality of second magnets 5 may be disposed spaced apart from each other in the direction of the center line A of the foldable electronic device 1.

According to an embodiment, as in an illustrated example, when the pen holder 33 is attached to the second case 32 through the plurality of second magnets 5, an attractive force between the plurality of second magnets 5 and the second case 32 may be configured to be stronger than an attractive force between the plurality of first magnets 4 and the first case 31. In a transition between an unfolded state and a folded state of the foldable electronic device 1, due to the attractive force between the plurality of second magnets 5 and the second case 32 being larger than the attractive force between the plurality of first magnets 4 and the first case 31, in the transition between the unfolded state and the folded state of the foldable electronic device 1, the pen holder 33 may be rotated with the plurality of second magnets 5 as an axis. An axis provided (or formed) by the plurality of second magnets 5 in a state in which the pen holder 33 is attached to the first case 31 may be substantially parallel to the center line A of the foldable electronic device 1.

According to an embodiment, when the pen holder 33 is attached to the second case 32 through the plurality of second magnets 5, due to the attractive force between the plurality of second magnets 5 and the second case 32 being larger than the attractive force between the plurality of first magnets 4 and the first case 31, a user experience guiding a user to open the pen holder 33 with the plurality of second magnets 5 as an axis (as a reference) may be provided.

According to an embodiment, when the pen holder 33 is attached to the second case 32 through the plurality of second magnets 5, in the transition between the unfolded state and the folded state of the foldable electronic device 1, the pen holder 33 is rotated with the plurality of second magnets 5 as an axis, and thus may not cover (or obstruct) a display area of the second display module 16.

According to an embodiment, although not separately illustrated, when the pen holder 33 is attached to the second case 32 through the plurality of first magnets 4, an attractive force between the plurality of first magnets 4 and the second case 32 may be configured to be stronger than an attractive force between the plurality of second magnets 5 and the first case 31. In the transition between the unfolded state and the folded state of the foldable electronic device 1, due to the attractive force between the plurality of first magnets 4 and the second case 32 being larger than the attractive force between the plurality of second magnets 5 and the first case 31, in the transition between the unfolded state and the folded state of the foldable electronic device 1, the pen holder 33 may be rotated with the plurality of first magnets 4 as an axis. An axis provided (or formed) by the plurality of first magnets 4 in a state in which the pen holder 33 is attached to the first case 31 may be substantially parallel to the center line A of the foldable electronic device 1.

According to an embodiment, although not separately illustrated, when the pen holder 33 is attached to the second case 32 through the plurality of first magnets 4, due to the attractive force between the plurality of first magnets 4 and the second case 32 being larger than the attractive force between the plurality of second magnets 5 and the first case 31, a user experience guiding a user to open the pen holder 33 with the plurality of first magnets 4 as an axis (as a reference) may be provided.

According to an embodiment, when the pen holder 33 is attached to the second case 32 through the plurality of first magnets 4, in a transition between an unfolded state and a folded state of the foldable electronic device 1, the pen holder 33 is rotated with the plurality of first magnets 4 as an axis, and thus may not cover a display area of the second display module 16.

According to an embodiment, the plurality of third magnets 6 may be disposed in the second case 32. The plurality of third magnets 6 may, for example, be positioned inside the second case 32 and may not be exposed to the outside. Through an attractive force between the plurality of second magnets 5 and the plurality of third magnets 6, the pen holder 33 may be attached to the second case 32. Through an attractive force between the plurality of first magnets 4 and the plurality of third magnets 6 of the second case 32, the pen holder 33 may be attached to the second case 32.

According to an embodiment, the plurality of first magnets 4 (or the plurality of second magnets 5) and the plurality of third magnets 6 may be provided in a one-to-one correspondence relationship. The one-to-one correspondence relationship may guide a position in which the pen holder 33 is attached to the second case 32 to a user.

According to an embodiment, the first case 31 may include a first area 3101 and a second area 3102 configured to apply an attractive force with the pen holder 33. When viewing the unfolded state of the foldable electronic device 1, the second area 3102 may be positioned closer to the plurality of third magnets 6 than the first area 3101.

According to an embodiment, as in an illustrated example, when the pen holder 33 is attached to the second case 32 through an attractive force between the plurality of second magnets 5 and the plurality of third magnets 6, in the unfolded state of the foldable electronic device 1, through an attractive force between the plurality of first magnets 4 and the first area 3101 of the first case 31, the pen holder 33 may be attached to the first case 31. When the pen holder 33 is attached to the second case 32 through the attractive force between the plurality of second magnets 5 and the plurality of third magnets 6, in the folded state of the foldable electronic device 1, through an attractive force between the plurality of first magnets 4 and the second area 3102 of the first case 31, the pen holder 33 may be attached to the first case 31. In the transition between the unfolded state and the folded state of the foldable electronic device 1, the pen holder 33 may be rotated with the plurality of second magnets 5 as an axis while maintaining a state in which the pen holder 33 is attached to the first case 31 through the plurality of first magnets 4.

According to an embodiment, although not separately illustrated, when the pen holder 33 is attached to the second case 32 through an attractive force between the plurality of first magnets 4 and the plurality of third magnets 6, in the unfolded state of the foldable electronic device 1, through an attractive force between the plurality of second magnets 5 and the first area 3101, the pen holder 33 may be attached to the first case 31. When the pen holder 33 is attached to the second case 32 through the attractive force between the plurality of first magnets 4 and the plurality of third magnets 6, in the folded state of the foldable electronic device 1, through an attractive force between the plurality of second magnets 5 and the second area 3102, the pen holder 33 may be attached to the first case 31. In the transition between the unfolded state and the folded state of the foldable electronic device 1, the pen holder 33 may be rotated with the plurality of first magnets 4 as an axis while maintaining a state in which the pen holder 33 is attached to the first case 31 through the plurality of second magnets 5.

According to an embodiment, a plurality of fourth magnets 7 may be disposed in the first area 3101 of the first case 31. As in an illustrated example, when the pen holder 33 is attached to the second case 32 through the attractive force between the plurality of second magnets 5 and the plurality of third magnets 6, in the unfolded state of the foldable electronic device 1, the pen holder 33 may be attached to the first case 31 through an attractive force between the plurality of first magnets 4 and the plurality of fourth magnets 7. Although not separately illustrated, when the pen holder 33 is attached to the second case 32 through the attractive force between the plurality of first magnets 4 and the plurality of third magnets 6, in the unfolded state of the foldable electronic device 1, the pen holder 33 may be attached to the first case 31 through an attractive force between the plurality of second magnets 5 and the plurality of fourth magnets 7.

According to an embodiment, the plurality of fifth magnets 8 may be disposed in the second area 3102 of the first case 31. As in an illustrated example, when the pen holder 33 is attached to the second case 32 through the attractive force between the plurality of second magnets 5 and the plurality of third magnets 6, in the folded state of the foldable electronic device 1, the pen holder 33 may be attached to the first case 31 through an attractive force between the plurality of first magnets 4 and the plurality of fifth magnets 8. Although not separately illustrated, when the pen holder 33 is attached to the second case 32 through the attractive force between the plurality of first magnets 4 and the plurality of third magnets 6, in the folded state of the foldable electronic device 1, the pen holder 33 may be attached to the first case 31 through an attractive force between the plurality of second magnets 5 and the plurality of fifth magnets 8.

According to various embodiments, for replacing the plurality of fourth magnets 7, at least one first magnetic body (e.g., a material that is magnetized in response to a magnet) may be disposed or included in the first area 3101 of the first case 31. In various embodiments, a combination of the plurality of fourth magnets 7 and the at least one first magnetic body may be disposed or included in the first area 3101 of the first case 31.

According to various embodiments, for replacing the plurality of fifth magnets 8, at least one second magnetic body (e.g., a material that is magnetized in response to a magnet) may be disposed or included in the second area 3102 of the first case 31. In various embodiments, a combination of the plurality of fifth magnets 8 and the at least one second magnetic body may be disposed or included in the second area 3102 of the first case 31.

According to various embodiments, a number and/or a position of the plurality of first magnets 4, the plurality of second magnets 5, the plurality of third magnets 6, the plurality of fourth magnets 7, and/or the plurality of fifth magnets 8 are not limited to an illustrated example and may vary. For example, for replacing the plurality of first magnets 4, one first magnet may be provided. For example, for replacing the plurality of second magnets 5, one second magnet may be provided. For example, for replacing the plurality of third magnets 6, one third magnet may be provided. For example, for replacing the plurality of fourth magnets 7, one fourth magnet may be provided. For example, for replacing the plurality of fifth magnets 8, one fifth magnet may be provided.

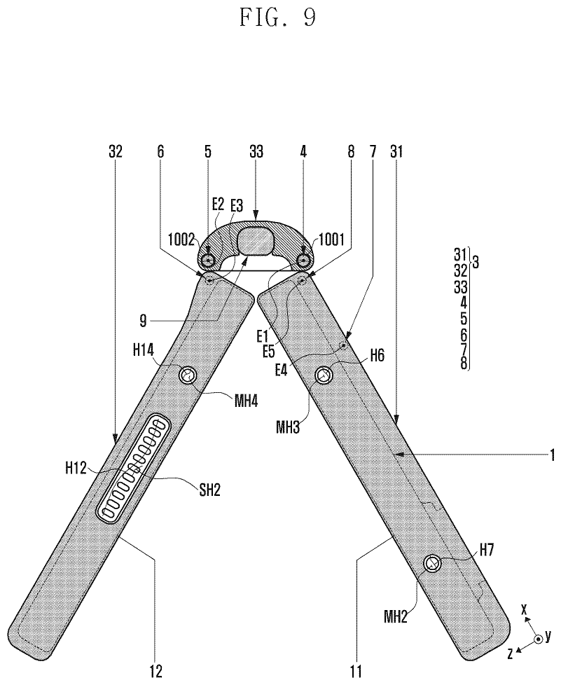

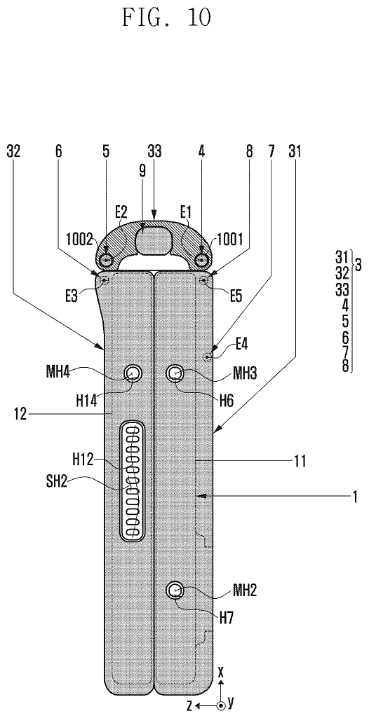

FIG. 8 is a partial cross-sectional view illustrating the combination of the foldable electronic device 1 and the outer case 3, according to an embodiment of the disclosure. FIG. 9 is a partial cross-sectional view illustrating an intermediate state of the combination of the foldable electronic device 1 and the outer case 3, according to an embodiment of the disclosure. FIG. 10 is a partial cross-sectional view illustrating the folded state of the combination of the foldable electronic device 1 and the outer case 3, according to an embodiment of the disclosure.

Referring to FIGS. 8, 9, and 10, the outer case 3 may include the first case 31, the second case 32, and the pen holder 33. The plurality of first magnets 4 and the plurality of second magnets 5 may be disposed in the pen holder 33. The plurality of third magnets 6 may be disposed in the second case 32. The plurality of fourth magnets 7 and the plurality of fifth magnets 8 may be disposed in the first case 31. Descriptions of some constituent elements having the same reference numerals as reference numerals illustrated in FIGS. 1, 2, 3, 4, 5, 6, and 7 are omitted.

According to an embodiment, the plurality of first and second magnets 4 and 5 of the pen holder 33 may be provided (or formed) in a cylindrical form. The plurality of first and second magnets 4 and 5 may, for example, be cylindrical magnets. The plurality of first and second magnets 4 and 5 may, for example, include two circular bottom surfaces disposed on opposite sides to each other in a direction of the center line A (with reference to FIG. 1) of the foldable electronic device 1, and a curved lateral surface connecting the two circular bottom surfaces. The plurality of first magnets 4 may have a first central axis E1 substantially parallel to the center line A of the foldable electronic device 1. The plurality of second magnets 5 may have a second central axis E2 substantially parallel to the center line A of the foldable electronic device 1.

According to an embodiment, each of the plurality of first magnets 4 (e.g., magnets 41, 42, 43, 44, 45), as a cylindrical magnet, may include an N pole and an S pole respectively disposed at opposite sides with respect to the first central axis E1. Each of the plurality of second magnets 5 (e.g., magnets 51, 52, 53, 54, 55), as a cylindrical magnet, may include an N pole and an S pole respectively disposed at opposite sides with respect to the second central axis E2.

According to an embodiment, the plurality of first magnets 4 may be disposed in the pen holder 33 to be substantially rotatable with respect to the first central axis E1. The pen holder 33 may include a plurality of first internal spaces 1001 in which the plurality of first magnets 4 is disposed. In order for the plurality of first magnets 4 to be substantially rotated with respect to the first central axis E1, a clearance between the plurality of first magnets 4 and surfaces of the plurality of first internal spaces 1001 may be provided (or formed). The surfaces of the plurality of first internal spaces 1001 may support rotation of the plurality of first magnets 4.

According to an embodiment, the plurality of second magnets 5 may be disposed in the pen holder 33 to be substantially rotatable with respect to the second central axis E2. The pen holder 33 may include a plurality of second internal spaces 1002 in which the plurality of second magnets 5 is disposed. In order for the plurality of second magnets 5 to be substantially rotated with respect to the second central axis E2, a clearance between the plurality of second magnets 5 and surfaces of the plurality of second internal spaces 1002 may be provided (or formed). The surfaces of the plurality of second internal spaces 1002 may support rotation of the plurality of second magnets 5.

According to an embodiment, the plurality of third magnets 6 may be provided (or formed) in a cylindrical form. The plurality of third magnets 6 may, for example, be cylindrical magnets. The plurality of third magnets 6 may, for example, include two circular bottom surfaces disposed on opposite sides to each other in a direction of the center line A (with reference to FIG. 1) of the foldable electronic device 1, and a curved lateral surface connecting the two circular bottom surfaces. The plurality of third magnets 6 may have a third central axis E3 substantially parallel to the center line A of the foldable electronic device 1.

According to an embodiment, each of the plurality of third magnets 6 (e.g., magnets 61, 62, 63, 64, 65), as a cylindrical magnet, may include an N pole and an S pole respectively disposed at opposite sides with respect to the third central axis E3.

According to an embodiment, the plurality of third magnets 6 may be disposed in the second case 32 to be substantially rotatable with respect to the third central axis E3. The second case 32 may include a plurality of third internal spaces (not separately illustrated) in which the plurality of third magnets 6 is disposed. In order for the plurality of third magnets 6 to be substantially rotated with respect to the third central axis E3, a clearance between the plurality of third magnets 6 and surfaces of the plurality of third internal spaces may be provided (or formed). The surfaces of the plurality of third internal spaces may support rotation of the plurality of third magnets 6.

According to an embodiment, configuring the plurality of second magnets 5 to be substantially rotatable with respect to the second central axis E2 and configuring the plurality of third magnets 6 to be substantially rotatable with respect to the third central axis E3 may reduce a decrease in an attachment force between the pen holder 33 and the second case 32, in an illustrated example in which the pen holder 33 is attached to the second case 32 through an attractive force between the plurality of second magnets 5 and the plurality of third magnets 6. For example, when the pen holder 33 is attached to the second case 32 through the attractive force between the plurality of second magnets 5 and the plurality of third magnets 6, the plurality of second magnets 5 and the plurality of third magnets 6 may be rotated relative to each other such that an N pole and an S pole are aligned in a direction facing each other. Configuring the plurality of second magnets 5 to be substantially rotatable with respect to the second central axis E2 and configuring the plurality of third magnets 6 to be substantially rotatable with respect to the third central axis E3 may reduce a decrease in an attractive force between the plurality of second magnets 5 and the plurality of third magnets 6, when, in a transition between an unfolded state and a folded state of the foldable electronic device 1, the pen holder 33 is rotated with the plurality of second magnets 5 as an axis while maintaining a state in which the pen holder 33 is attached to the first case 31 through the plurality of first magnets 4. In the transition between the unfolded state and a folded state of the foldable electronic device 1, the plurality of second magnets 5 and the plurality of third magnets 6 may be rotated relative to each other such that an N pole and an S pole are aligned in a direction facing each other.

According to an embodiment, configuring the plurality of first magnets 4 to be substantially rotatable with respect to the first central axis E1 and configuring the plurality of third magnets 6 to be substantially rotatable with respect to the third central axis E3 may reduce a decrease in an attachment force between the pen holder 33 and the second case 32, in an example (not separately illustrated) in which the pen holder 33 is attached to the second case 32 through an attractive force between the plurality of first magnets 4 and the plurality of third magnets 6. For example, when the pen holder 33 is attached to the second case 32 through the attractive force between the plurality of first magnets 4 and the plurality of third magnets 6, the plurality of first magnets 4 and the plurality of third magnets 6 may be rotated relative to each other such that an N pole and an S pole are aligned in a direction facing each other. Configuring the plurality of first magnets 4 to be substantially rotatable with respect to the first central axis E1 and configuring the plurality of third magnets 6 to be substantially rotatable with respect to the third central axis E3 may reduce a decrease in an attractive force between the plurality of first magnets 4 and the plurality of third magnets 6, when, in a transition between an unfolded state and a folded state of the foldable electronic device 1, the pen holder 33 is rotated with the plurality of first magnets 4 as an axis while maintaining a state in which the pen holder 33 is attached to the first case 31 through the plurality of second magnets 5. In a transition between an unfolded state and a folded state of the foldable electronic device 1, the plurality of first magnets 4 and the plurality of third magnets 6 may be rotated relative to each other such that an N pole and an S pole are aligned in a direction facing each other.

According to an embodiment, the plurality of fourth magnets 7 may be provided (or formed) in a cylindrical form. The plurality of fourth magnets 7 may, for example, be cylindrical magnets. The plurality of fourth magnets 7 may, for example, include two circular bottom surfaces disposed on opposite sides to each other in a direction of the center line A (with reference to FIG. 1) of the foldable electronic device 1, and a curved lateral surface connecting the two circular bottom surfaces. The plurality of fourth magnets 7 may have a fourth central axis E4 substantially parallel to the center line A of the foldable electronic device 1.

According to an embodiment, each of the plurality of fourth magnets 7 (e.g., magnets 71, 72, 73, 74, 75), as a cylindrical magnet, may include an N pole and an S pole respectively disposed at opposite sides with respect to the fourth central axis E4.

According to an embodiment, the plurality of fourth magnets 7 may be disposed in the first case 31 to be substantially rotatable with respect to the fourth central axis E4. The first case 31 may include a plurality of fourth internal spaces (not separately illustrated) in which the plurality of fourth magnets 7 is disposed. In order for the plurality of fourth magnets 7 to be substantially rotated with respect to the fourth central axis E4, a clearance between the plurality of fourth magnets 7 and surfaces of the plurality of fourth internal spaces may be provided (or formed). The surfaces of the plurality of fourth internal spaces may support rotation of the plurality of fourth magnets 7.

According to an embodiment, configuring the plurality of fourth magnets 7 to be substantially rotatable with respect to the fourth central axis E4 may help the plurality of first magnets 4 and the plurality of fourth magnets 7 to be aligned such that an N pole and an S pole are in a direction facing each other, and may improve an attachment force between the pen holder 33 and the first case 31, when, in an illustrated example in which the pen holder 33 is attached to the second case 32 through an attractive force between the plurality of second magnets 5 and the plurality of third magnets 6, the foldable electronic device 1 is in an unfolded state.

According to an embodiment, configuring the plurality of fourth magnets 7 to be substantially rotatable with respect to the fourth central axis E4 may help the plurality of second magnets 5 and the plurality of fourth magnets 7 to be aligned such that an N pole and an S pole are in a direction facing each other, and may improve an attachment force between the pen holder 33 and the first case 31, when, in an example (not separately illustrated) in which the pen holder 33 is attached to the second case 32 through an attractive force between the plurality of first magnets 4 and the plurality of third magnets 6, the foldable electronic device 1 is in an unfolded state.

According to an embodiment, the plurality of fifth magnets 8 may be provided (or formed) in a cylindrical form. The plurality of fifth magnets 8 may, for example, be cylindrical magnets. The plurality of fifth magnets 8 may, for example, include two circular bottom surfaces disposed on opposite sides to each other in a direction of the center line A (with reference to FIG. 1) of the foldable electronic device 1, and a curved lateral surface connecting the two circular bottom surfaces. The plurality of fifth magnets 8 may have a fifth central axis E5 substantially parallel to the center line A of the foldable electronic device 1.

According to an embodiment, each of the plurality of fifth magnets 8 (e.g., magnets 81, 82, 83, 84, 85), as a cylindrical magnet, may include an N pole and an S pole respectively disposed at opposite sides with respect to the fifth central axis E5.

According to an embodiment, the plurality of fifth magnets 8 may be disposed in the first case 31 to be substantially rotatable with respect to the fifth central axis E5. The first case 31 may include a plurality of fifth internal spaces (not separately illustrated) in which the plurality of fifth magnets 8 is disposed. In order for the plurality of fifth magnets 8 to be substantially rotated with respect to the fifth central axis E5, a clearance between the plurality of fifth magnets 8 and surfaces of the plurality of fifth internal spaces may be provided (or formed). The surfaces of the plurality of fifth internal spaces may support rotation of the plurality of fifth magnets 8.

According to an embodiment, configuring the plurality of fifth magnets 8 to be substantially rotatable with respect to the fifth central axis E5 may help the plurality of first magnets 4 and the plurality of fifth magnets 8 to be aligned such that an N pole and an S pole are in a direction facing each other, and may improve an attachment force between the pen holder 33 and the first case 31, when, in an illustrated example in which the pen holder 33 is attached to the second case 32 through an attractive force between the plurality of second magnets 5 and the plurality of third magnets 6, the foldable electronic device 1 is in a folded state.

According to an embodiment, configuring the plurality of fifth magnets 8 to be substantially rotatable with respect to the fifth central axis E5 may help the plurality of second magnets 5 and the plurality of fifth magnets 8 to be aligned such that an N pole and an S pole are in a direction facing each other, and may improve an attachment force between the pen holder 33 and the first case 31, when, in an example (not separately illustrated) in which the pen holder 33 is attached to the second case 32 through an attractive force between the plurality of first magnets 4 and the plurality of third magnets 6, the foldable electronic device 1 is in a folded state.

According to various embodiments, for smooth and soft rotation of the plurality of first magnets 4, a lubricant material (e.g., grease (grease)) may be disposed in the plurality of first internal spaces 1001 of the pen holder 33 in which the plurality of first magnets 4 is disposed. For smooth and soft rotation of the plurality of second magnets 5, a lubricant material (e.g., grease) may be disposed in the plurality of second internal spaces 1002 of the pen holder 33 in which the plurality of second magnets 5 is disposed.

According to various embodiments, for smooth and soft rotation of the plurality of third magnets 3, a lubricant material (e.g., grease) may be disposed in the plurality of third internal spaces (not separately illustrated) of the second case 32 in which the plurality of third magnets 3 is disposed.

According to various embodiments, for smooth and soft rotation of the plurality of fourth magnets 4, a lubricant material (e.g., grease) may be disposed in the plurality of fourth internal spaces (not separately illustrated) of the first case 31 in which the plurality of fourth magnets 4 is disposed.

According to various embodiments, for smooth and soft rotation of the plurality of fifth magnets 5, a lubricant material (e.g., grease) may be disposed in the plurality of fifth internal spaces (not separately illustrated) of the first case 31 in which the plurality of fifth magnets 5 is disposed.

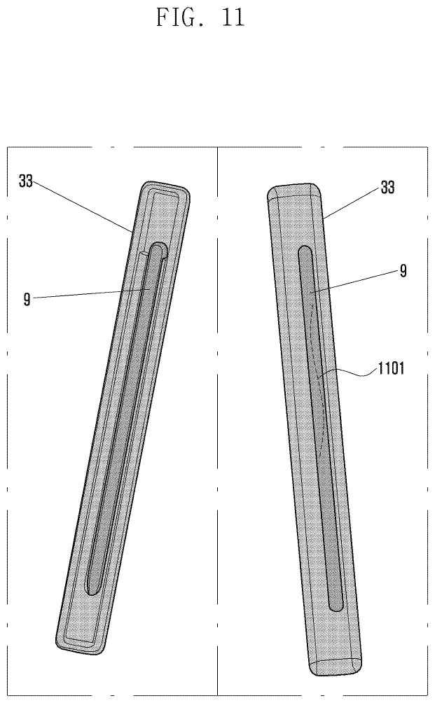

FIG. 11 is perspective views illustrating a state in which the pen input device 9 is attached to the pen holder 33, according to an embodiment of the disclosure.

Referring to FIG. 11, the pen holder 33 may include an opening 1101. The pen input device 9 attached to the pen holder 33 may be exposed to the outside through the opening 1101. A user may push the pen input device 9 through the opening 1101 to separate the pen input device 9 from the pen holder 33.

According to an embodiment, a part of the pen input device 9 may be configured to be inserted into the opening 1101 of the pen holder 33. A part of the pen input device 9 being inserted into the opening 1101 of the pen holder 33 may reduce a thickness of a combination of the pen input device 9 and the pen holder 33.

According to an embodiment of the disclosure, the outer case 3 for the foldable electronic device 1 includes the first case 31, the second case 32, the pen hole 33, a first magnet (e.g., the plurality of first magnets 4), a second magnet (e.g., the plurality of second magnets 5), a third magnet (e.g., the plurality of third magnets 6), a fourth magnet (e.g., the plurality of fourth magnets 7), and/or a fifth magnet (e.g., the plurality of fifth magnets 8). The first case 31 is configured to be attached to the first housing 11 of the foldable electronic device. The second case 32 is configured to be attached to the second housing 12 of the foldable electronic device 1 hinge-connected to the first housing 11. The pen holder 33 is configured to position on the hinge housing 13 between the first housing 11 and the second housing 12 when the foldable electronic device 1 is in a folding state and to accommodate a pen (e.g., the pen input device 9). The first magnet is disposed in the pen holder 33. The second magnet is disposed in the pen holder 33. The third magnet is disposed in the second case 32. The fourth magnet is disposed in the first case 31. The fifth magnet is disposed in the first case 31. One end of the pen holder 33 is attached to the second case 32 through an attractive force between the second magnet and the third magnet. In an unfolding state of the foldable electronic device 1, through an attractive force between the first magnet and the fourth magnet, the other end of the pen holder 33 is attached to the first case 31. In a folding state of the foldable electronic device 1, through an attractive force between the first magnet and the fifth magnet, the other end of the pen holder 33 is attached to the first case 31.

According to an embodiment of the disclosure, an attractive force between the second magnet (e.g., the plurality of second magnets 5) and the third magnet (e.g., the plurality of third magnets 6) may be configured to be stronger than an attractive force between the first magnet (e.g., the plurality of first magnets 4) and the fourth magnet (e.g., the plurality of fourth magnets 7) in an unfolding state of the foldable electronic device 1. An attractive force between the second magnet and the third magnet may be configured to be stronger than an attractive force between the first magnet and the fifth magnet (e.g., the plurality of fifth magnets 8) in a folding state of the foldable electronic device 1.

According to an embodiment of the disclosure, the first magnet (e.g., the plurality of first magnets 4) includes a first central axis E1 parallel to a folding axis (e.g., center line A) of the foldable electronic device 1, and may be disposed in the pen holder 33 to be rotatable with respect to the first central axis E1. The second magnet (e.g., the plurality of second magnets 5) includes a second central axis E2 parallel to the folding axis of the foldable electronic device 1, and may be disposed in the pen holder 33 to be rotatable with respect to the second central axis E2.

According to an embodiment of the disclosure, the first magnet (e.g., the plurality of first magnets 4) may be a cylindrical magnet in which an N pole and an S pole are respectively disposed at opposite sides with respect to the first central axis E1. The second magnet (e.g., the plurality of second magnets 5) may be a cylindrical magnet in which an N pole and an S pole are respectively disposed at opposite sides with respect to the second central axis E2.

According to an embodiment of the disclosure, the third magnet (e.g., the plurality of third magnets 6) includes a third central axis E3 parallel to a folding axis (e.g., center line A) of the foldable electronic device 1, and may be disposed in the second case 32 to be rotatable with respect to the third central axis E3.

According to an embodiment of the disclosure, the third magnet (e.g., the plurality of third magnets 6) may be a cylindrical magnet in which an N pole and an S pole are respectively disposed at opposite sides with respect to the third central axis E3.

According to an embodiment of the disclosure, the fourth magnet (e.g., the plurality of fourth magnets 7) includes a fourth central axis E4 parallel to a folding axis (e.g., center line A) of the foldable electronic device 1, and may be disposed in the first case 31 to be rotatable with respect to the fourth central axis E4. The fifth magnet (e.g., the plurality of fifth magnets 8) includes a fifth central axis E5 parallel to the folding axis of the foldable electronic device 1, and may be disposed in the first case 31 to be rotatable with respect to the fifth central axis E5.

According to an embodiment of the disclosure, the fourth magnet (e.g., the plurality of fourth magnets 7) may be a cylindrical magnet in which an N pole and an S pole are respectively disposed at opposite sides with respect to the fourth central axis E4. The fifth magnet (e.g., the plurality of fifth magnets 8) may be a cylindrical magnet in which an N pole and an S pole are respectively disposed at opposite sides with respect to the fifth central axis E5.

According to an embodiment of the disclosure, the pen holder 33 may include the opening 1101 to expose a pen (e.g., pen input device 9) to the outside.

According to an embodiment of the disclosure, the outer case 3 for the foldable electronic device 1 includes the first case 31, the second case 32, the pen holder 33, at least one first magnet (e.g., the plurality of first magnets 4), and/or at least one second magnet (e.g., the plurality of second magnets 5). The first case 31 is configured to be attached to the first housing 11 of the foldable electronic device 1. The second case 32 is configured to be attached to the second housing 12 of the foldable electronic device 1 hinge-connected to the first housing 11. The pen holder 33 is configured to cover the hinge housing 13 between the first housing 11 and the second housing 12 when the foldable electronic device 1 is in a folding state, and to accommodate a pen 9. The at least one first magnet is disposed in the pen holder 33, and provides a magnetic force to attach the pen holder 33 to the first case 31. The at least one second magnet is disposed in the pen holder 33, and provides a magnetic force to attach the pen holder 33 to the second case 32. An attractive force between the at least one second magnet and the second case is configured to be stronger than an attractive force between the at least one first magnet and the first case.

According to an embodiment of the disclosure, the outer case 3 may include at least one third magnet (e.g., the plurality of third magnets 6) disposed in the second case 32 corresponding to at least one second magnet (e.g., the plurality of second magnets 5).

According to an embodiment of the disclosure, the at least one second magnet (e.g., the plurality of second magnets 5) may include a central axis (e.g., the second central axis E2) parallel to a folding axis (e.g., center line A) of the foldable electronic device 1, may be a cylindrical magnet in which an N pole and an S pole are respectively disposed at opposite sides with respect to the central axis, and may be disposed in the pen holder 33 to be rotatable with respect to the central axis. The at least one third magnet (e.g., the plurality of third magnets 6) may include a central axis (e.g., the third central axis E3) parallel to the folding axis, may be a cylindrical magnet in which an N pole and an S pole are respectively disposed at opposite sides with respect to the central axis, and may be disposed in the second case 32 to be rotatable with respect to the central axis.

According to an embodiment of the disclosure, in an unfolding state of the foldable electronic device 1, the at least one first magnet (e.g., the plurality of first magnets 4) may be configured to act an attractive force on the first area 3101 of the first case 31. In a folding state of the foldable electronic device 1, the at least one first magnet may be configured to act an attractive force on the second area 3102 of the first case 31.

According to an embodiment of the disclosure, the first area 3101 of the first case 31 may include at least one fourth magnet (e.g., the plurality of fourth magnets 7). The second area 3102 of the first case 31 may include at least one fifth magnet (e.g., the plurality of fifth magnets 8).

According to an embodiment of the disclosure, the at least one fourth magnet (e.g., the plurality of fourth magnets 7) may include a central axis (e.g., the fourth central axis E4) parallel to a folding axis (e.g., center line A) of the foldable electronic device 1, may be a cylindrical magnet in which an N pole and an S pole are respectively disposed at opposite sides with respect to the central axis E4, and may be disposed in the first case 31 to be rotatable with respect to the central axis E4. The at least one fifth magnet (e.g., the plurality of fifth magnets 8) may include a central axis (e.g., the fifth central axis E5) parallel to the folding axis, may be a cylindrical magnet in which an N pole and an S pole are respectively disposed at opposite sides with respect to the central axis, and may be disposed in the first case 31 to be rotatable with respect to the central axis.

The embodiments disclosed in the disclosure and illustrated in the drawings are provided as particular examples for more easily explaining the technical contents according to the disclosure and helping understand the disclosure, but not intended to limit the scope of the disclosure. Accordingly, the scope of the various embodiments of the disclosure should be interpreted as including alterations or modifications in addition to the disclosed embodiments. Additionally, it will be understood that any embodiment(s) described herein may be used in conjunction with any other embodiment(s) described herein. In particular, the disclosure has been presented in a form of providing a plurality of embodiments respectively defining a plurality of features, but it is emphasized that some among these embodiments are connected only by reference to the same drawing or drawings. The disclosure should be understood as including all combinations of these embodiments unless there is no clear contradiction between two (or more) embodiments. That is, when features are presented as optional in the disclosure, all combinations of such optional features are included in the disclosure.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An outer case for a foldable electronic device, the outer case comprising:
a first case configured to be attached to a first housing of the foldable electronic device;
a second case configured to be attached to a second housing of the foldable electronic device hinge-connected to the first housing;
a pen holder configured to be positioned at a hinge housing between the first housing and the second housing when the foldable electronic device is in a folding state and to accommodate a pen;
a first magnet disposed in the pen holder;
a second magnet disposed in the pen holder;
a third magnet disposed in the second case;
a fourth magnet disposed in the first case; and
a fifth magnet disposed in the first case,
wherein one end of the pen holder is attached to the second case through an attractive force between the second magnet and the third magnet,
wherein in an unfolding state of the foldable electronic device the other end of the pen holder is attached to the first case through an attractive force between the first magnet and the fourth magnet, and
wherein in the folding state of the foldable electronic device, the other end of the pen holder is attached to the first case through an attractive force between the first magnet and the fifth magnet.

2. The outer case of claim 1,
wherein an attractive force between the second magnet and the third magnet is configured to be stronger than an attractive force between the first magnet and the fourth magnet in the unfolding state of the foldable electronic device, and
wherein the attractive force between the second magnet and the third magnet is configured to be stronger than an attractive force between the first magnet and the fifth magnet in the folding state of the foldable electronic device.

3. The outer case of claim 1,
wherein the first magnet includes a first central axis parallel to a folding axis of the foldable electronic device, and is disposed in the pen holder to be rotatable with respect to the first central axis, and
wherein the second magnet includes a second central axis parallel to the folding axis of the foldable electronic device, and is disposed in the pen holder to be rotatable with respect to the second central axis.

4. The outer case of claim 3,
wherein the first magnet is a cylindrical magnet in which an N pole and an S pole are respectively disposed at opposite sides with respect to the first central axis, and
wherein the second magnet is a cylindrical magnet in which an N pole and an S pole are respectively disposed at opposite sides with respect to the second central axis.

5. The outer case of claim 1, wherein the third magnet includes a third central axis parallel to the folding axis of the foldable electronic device, and is disposed in the second case to be rotatable with respect to the third central axis.

6. The outer case of claim 5, wherein the third magnet is a cylindrical magnet in which an N pole and an S pole are respectively disposed at opposite sides with respect to the third central axis.

7. The outer case of claim 1,
wherein the fourth magnet includes a fourth central axis parallel to the folding axis of the foldable electronic device, and is disposed in the first case to be rotatable with respect to the fourth central axis, and
wherein the fifth magnet includes a fifth central axis parallel to the folding axis of the foldable electronic device, and is disposed in the first case to be rotatable with respect to the fifth central axis.

8. The outer case of claim 7,
wherein the fourth magnet is a cylindrical magnet in which an N pole and an S pole are respectively disposed at opposite sides with respect to the fourth central axis, and
wherein the fifth magnet is a cylindrical magnet in which an N pole and an S pole are respectively disposed at opposite sides with respect to the fifth central axis.

9. The outer case of claim 1, wherein the pen holder includes an opening to expose the pen to the outside.

10. An outer case for a foldable electronic device, the outer case comprising:
a first case configured to be attached to a first housing of the foldable electronic device;
a second case configured to be attached to a second housing of the foldable electronic device hinge-connected to the first housing;
a pen holder configured to cover a hinge housing between the first housing and the second housing when the foldable electronic device is in a folding state, and to accommodate a pen;
at least one first magnet disposed in the pen holder and providing a magnetic force to attach the pen holder to the first case; and
at least one second magnet disposed in the pen holder and providing a magnetic force to attach the pen holder to the second case,
wherein an attractive force between the at least one second magnet and the second case is configured to be stronger than an attractive force between the at least one first magnet and the first case.

11. The outer case of claim 10, comprising at least one third magnet disposed in the second case corresponding to the at least one second magnet.

12. The outer case of claim 11,
wherein the at least one second magnet includes a central axis parallel to a folding axis of the foldable electronic device, is a cylindrical magnet in which an N pole and an S pole are respectively disposed at opposite sides with respect to the central axis, and is disposed in the pen holder to be rotatable with respect to the central axis, and
wherein the at least one third magnet includes a central axis parallel to the folding axis, is a cylindrical magnet in which an N pole and an S pole are respectively disposed at opposite sides with respect to the central axis, and is disposed in the second case to be rotatable with respect to the central axis.

13. The outer case of claim 10,
wherein in an unfolding state of the foldable electronic device, the at least one first magnet is configured to act an attractive force on a first area of the first case, and
wherein in the folding state of the foldable electronic device, the at least one first magnet is configured to act an attractive force on a second area of the first case.

14. The outer case of claim 13,
wherein the first area of the first case includes at least one fourth magnet, and
wherein the second area of the first case includes at least one fifth magnet.

15. The outer case of claim 14,
wherein the at least one fourth magnet includes a central axis parallel to the folding axis of the foldable electronic device, is a cylindrical magnet in which an N pole and an S pole are respectively disposed at opposite sides with respect to the central axis, and is disposed in the first case to be rotatable with respect to the central axis, and
wherein the at least one fifth magnet includes a central axis parallel to the folding axis, is a cylindrical magnet in which an N pole and an S pole are respectively disposed at opposite sides with respect to the central axis, and is disposed in the first case to be rotatable with respect to the central axis.
